(19) United States
(12) Patent Application Publication
(10) Pub. No.: US 2013/0284913 A1
(43) Pub. Date: Oct. 31, 2013

(54) Process for Monitoring Industrial Fluids and Treatment of Same

(71) Applicants: Sai Reddy Pinappu, Houston, TX (US); Bradley G. Harrell, Pearland, TX (US); Randy G. Rechtien, St. Louis, MO (US); Jerry J. Weers, Richmond, TX (US); Corina L. Sandu, Pearland, TX (US); J. Michael Brown, Lago Vista, TX (US)

(72) Inventors: Sai Reddy Pinappu, Houston, TX (US); Bradley G. Harrell, Pearland, TX (US); Randy G. Rechtien, St. Louis, MO (US); Jerry J. Weers, Richmond, TX (US); Corina L. Sandu, Pearland, TX (US); J. Michael Brown, Lago Vista, TX (US)

(73) Assignee: Baker Hughes Incorporated, Houston, TX (US)

(21) Appl. No.: 13/872,786

(22) Filed: Apr. 29, 2013

Related U.S. Application Data
(60) Provisional application No. 61/640,485, filed on Apr. 30, 2012.

(51) Int. Cl. G01N 27/62

(52) U.S. Cl. CPC G01N 27/624
USPC 250/282; 250/281; 252/73; 208/14

(57) ABSTRACT

Industrial fluids can be monitored by employing differential ion mobility spectrometer to sample the industrial fluids. This process may also include controlling an industrial device or an industrial process using the results of the output from the field asymmetric ion mobility spectrometer. The process may also include employing a device to condition the sample prior to introducing the sample into field asymmetric ion mobility spectrometer.

### CROSS REFERENCE TO RELATED APPLICATIONS

This application claims the benefit of U.S. Provisional Patent Application Ser. No. 61/640,485 filed Apr. 30, 2012, incorporated herein by reference in its entirety.

### BACKGROUND OF THE DISCLOSURE

1. Field of the Invention

The disclosure relates to monitoring industrial fluid. The disclosure particularly relates to such monitoring as part of a process for then treating the industrial fluid.

2. Background of the Art

It is often desirable to monitor industrial fluids. For example, a dynamic process feed stream in a chemical manufacturing process may require close monitoring in order to maintain the quality of a product or intermediate material being prepared. While desirable, monitoring industrial fluids is not always trouble free. There are many factors which may impact such monitoring.

One such factor is safety. In the refining of crude oil, heat and high pressure are employed to transform crude oil into gasoline and other petroleum products. Many of these materials are volatile and flammable. Some are even toxic.

Another factor is efficiency. For example, if a process for monitoring an industrial fluid requires that a sample be taken from and an inaccessible or remote location, then the cost for the monitoring may exceed its value.

Still another factor is timeliness. With the advent of controllers employing computers for operating parts, often substantial parts, of industrial processes, real time analysis has become important to fully exploiting the features of such controllers to track and capture anomalous events. It would be desirable in the art to employ a process for monitoring industrial fluids that was safe and efficient and could be deployed to produce real time or near real time results.

### SUMMARY OF THE INVENTION

In one aspect, the invention is a process for monitoring industrial fluids comprising employing differential ion mobility spectrometry to sample the industrial fluids. This process may also include controlling an industrial device or an industrial process using the results of the output from the field asymmetric ion mobility spectrometer. The process may also include employing a device to condition the sample prior to introducing the sample into field asymmetric ion mobility spectrometer.

In another aspect, the invention is a composition comprising an intermediate product or a final product produced in an industrial process employing a field asymmetric ion mobility spectrometry which is used to sample industrial fluids wherein the intermediate product or final product is compositionally distinct from a product prepared not using a differential ion mobility spectrometer.

In still another aspect, the invention is a system comprising a differential ion mobility spectrometer, a process controller, and an interface between the field asymmetric ion mobility spectrometer, and process controller.

### BRIEF DESCRIPTION OF THE DRAWING

The above and other features and advantages of the present invention will become more apparent by describing in detail embodiments thereof with reference to the attached drawing in which the figure illustrates the system of Hypothetical Example 1.

### DETAILED DESCRIPTION

For the purposes of this application, the term “industrial fluids” includes both gas and liquids. It also includes materials that may be solid at ambient temperatures but are fluid during an industrial process. Industrial fluids are limited to aqueous and non-aqueous fluids, including emulsions and other multiphase fluids which are admixtures of aqueous and non-aqueous fluids and which are present: in the exploration for or production of oil and gas, during the refining of crude oil, and during the production of chemical products.

For the purposes of this application, industrial fluids specifically include, but are not limited to: cooling water, process water, oil field drilling and completion fluids, oil and gas well production fluids, crude oil, feed streams to desalting units, outflow from desalting units, refinery and chemical plant heat transfer fluids, gas scrubber fluids, chemical plant and refinery unit feed streams, refinery and chemical plant intermediate streams, and refinery and chemical plant production and finished product streams.

In the practice of the process of the application, differential ion mobility spectrometry (DMS) such as field asymmetric ion mobility spectrometry (FAIMS) is employed to monitor an industrial fluid. In one embodiment of the invention, DMS is based on gas phase separation of ions due to difference in their mobilities in high and low electric fields. These separated ions may be quantified. In this method ions are made to flow through a gap between two parallel electrodes by using a carrier gas (usually air or an inert gas such as nitrogen) and an asymmetric oscillating electric field is applied (often by use of electromagnetic waves, such as those at radio frequencies) perpendicular to direction of gas flow. These electric fields may, in some embodiments, range from <1000 V/cm as low fields to about 20,000 to 30,000 V/cm as high fields at from about 0.7 to about 1.5 MHz.

The asymmetric field between the electrodes induces oscillating motion to ions which leads to collisions of these ions with electrode surfaces and subsequent ion losses but for the ions of interest this is prevented by adding an appropriate dc potential called compensation voltage (CV) which will offset the net displacement caused by asymmetric field and keep the ions of interest in the gas flow or at the center of the gap which, in some embodiments, may be detected using a faraday plate. The compensation voltage is a characteristic for an ion of interest at given conditions of temperature, moisture and separating field. The compensation voltage for analytes of interest can be determined by sweeping a range of voltages and monitoring the emerging ions at the detector.

Any apparatus incorporating DMS may be used with the process of the disclosure. For example, an apparatus incorporating FAIMS may be used with the process of the disclosure. Hybrid systems may also be used. For example, in one embodiment of the invention, a tandem apparatus employing DMS and ion mobility spectroscopy (IMS) may be employed within the process of the disclosure. While DMS is a comparatively new analysis technique, DMS based devices such as FAIMS analyzers are commercially available. For example, Owlstone, Inc. has a commercially available apparatus. The Charles Stark Draper Laboratory, Inc., one of the first entities to work in this field, also has offerings in this area.

In employing DMS, sometimes samples may be introduced directly from the industrial fluid or industrial fluid stream directly into the DMS apparatus. Limitations on applying this method are the same as any other DMS apparatus. For example, the fluid can be mobile enough to enter the instrument and ions be detectable the fluid can be sufficiently volatile that the fluid can be vaporized and the resultant gas can then pass through the detector without condensing or decomposing.

Because not all fluids meet the limitations set out hereinabove it is sometimes necessary to employ a device to pre-treat the industrial fluid. Any method known to those of ordinary skill in the art to be useful for this application may be employed with the process of the disclosure. For example, in one embodiment an industrial fluid may be treated with a pre-concentrator to increase the relative concentration of an analyte of interest, reducing the presence of an undesirable fluid. In another embodiment, an industrial fluid may be subjected to an extraction process. In still another embodiment, the industrial fluids may be subjected to prior heating or a first separation process, such as gas chromatography, prior to being introduced into the DMS apparatus.

While a DMS apparatus may be employed manually, the fact that it produces results in real time or at least near real time allows it to be employed in automated process control applications. For the purposes of this application, the term “real time” means generally “sufficiently fast enough to be employed in controlling an industrial process” and specifically less than about 10 minutes. In some embodiments, a DMS apparatus may produce results in less than about 5 minutes. In still other embodiments, a DMS apparatus may produce results in less than about 2 minutes.

Analysis of the sample by DMS necessarily requires that the sample be ionizable. Any method known to those of ordinary skill in the art to be useful for ionizing samples may be employed with the process of the disclosure. For example, in one embodiment of the invention of the disclosure, electrospray ionization may be used. In another embodiment, matrix-assisted laser desorption ionization or fast atom bombardment may be employed. In still another embodiment, chemical treatment or derivatization agents may be employed to pre-treat a fluid to facilitate volatilization of the species to be investigated.

In some embodiments of the process of the disclosure, the process also includes controlling an industrial device or an industrial process using the results of the output from a DMS apparatus. In one embodiment, the output may be employed directly to control an element of the process. For example, an undesirable compound may be monitored and a valve or pump operated to either speed up or slow down a specific process stream in response to the concentration of the undesirable compound. In another example, the input is used to change the pH of a process stream. In still another example, the process of the disclosure may be used to optimize the dosage of additives such as corrosion inhibitors, hydrate inhibitors, anti-fouling agents, antifoaming agents, anti-scaling agents, demulsifiers, and the like.

In another embodiment, the output from a DMS apparatus is employed as input into a computer model of a process. This aspect of the processes of the disclosure is particularly valuable in complex refining and chemical production units. In such applications, there may be many inputs which when crunched by the model cause changes to a number of process variables. For example, an increase in the undesirable component may require a change to not just a single flow of a single string but rather changes being made to half a dozen feed stream rates and an increase in temperature and or pressures. In some embodiments, the input may be from a DMS apparatus in a first unit within a refinery, but the input may require changes to production units either upstream or downstream from the unit where the measurement is actually made.

Another example of an advantage of a DMS apparatus is that it may be easily transported to remote locations. There are many applications where would be desirable to monitor industrial fluids at remote locations. For example many oil wells are located in very remote locations and it would be desirable in the art to take measurements directly at the wellhead in some applications.

Whether used remotely, such as at a collection point for a pipeline transporting crude oil, or used directly in a refinery, the processes of the disclosure may be used to control the addition of “additives” to a unit or to an oil well or even to a finished or intermediate product. For example, in a particularly desirable application, a DMS apparatus may be used with a Baker Hughes Sentry System™ to control the flow of additives to an oil well. In one embodiment, the flow of corrosion inhibitors can be so controlled. In yet another embodiment, the hydrogen sulfide scavenger can be introduced into an oil well using such a system. In a refinery, other additives such as a defoamer may be employed. Any additive known to be useful to those of ordinary skill in the art may be employed using the process of the disclosure.

In another aspect, the invention is a composition comprising an intermediate product or a final product produced in an industrial process employing a field asymmetric ion mobility spectrometer which is used to sample industrial fluids wherein the intermediate product or final product is compositionally distinct from a product prepared not using a DMS apparatus.

One embodiment of the invention is a composition comprising an intermediate product or a final product produced in an industrial process employing a field asymmetric ion mobility spectrometer which is used to sample industrial fluids wherein the intermediate product or final product is distinct from a product prepared not using a DMS apparatus. The following applications are exemplary, but not limiting, of this embodiment.

In one application of the process of the disclosure, a DMS apparatus may be employed to monitor fuels. For example, in one embodiment gasoline may be monitored for the presence of, for example ethanol. Generally, other compounds which could be monitored include primary, secondary, and tertiary alcohols; amines; carboxylic acids used as corrosion inhibitors, detergents, emissions reduction additives; and the like.

Even diesel fuel can be monitored. For example, beta-carotene and ethylhexyl nitrate are sometimes found in diesel fuel. The process of the disclosure may be employed to monitor diesel fuel for the presence of beta-carotene and/or ethylhexyl nitrate.

While in many instances industrial fluids can be monitored for the specific compound interest, it is sometimes necessary to do and indirectly. For example, cetane improvers in diesel fuel may be monitored by determining the levels of organic nitrates. Carboxylic acids, amides or esters used as lubricity aids corrosion inhibitors and dispersants; amines used as antioxidants, and esters used in biofuels etc. could also be monitored using the process of the disclosure.

Heat transfer systems may be monitored and employing the process of the disclosure. In such systems employing Freon®, the exterior of the system may be monitored for the presence of Freon as evidence of a leak. In systems utilizing water as the transfer medium, the water may be monitored for the presence of undesirable compounds. Such compounds can be undesirable because they are damaging to the system, like a corrosive material. In the alternative, the undesirable compounds may be undesirable because they indicate the presence of a leak. For example, cooling water can be monitored for the presence of an amine when the cooling water is used to remove heat from a process stream including amines.

While any industrial fluid may be monitored using a DMS apparatus and still be within the scope of the disclosure; it may be desirable to so monitor any of the following compounds: primary, secondary, and tertiary amines; organic halides; organic acids and their salts (commonly occurring corrosive compounds); quaternary amines (pyridines); poly acids; dimer-trimer acids; and halogenated organic acids. As briefly mentioned above, fuels such as diesel fuel a specific compounds of interest. For example, in addition the beta-carotene, it may be desirable to monitor fuels and bio-diesel fuel in specific for compounds such as fatty acid methyl esters; acid derivatives (imides, amides, lactones, and lactams).

In another diesel fuel application, the fatty acid methyl esters may be used as an indication of the presence of lubricity additives.

Another application may be the monitoring of hydrogen sulfide in heavy fuels (such as bunker “C” and the like) and asphalt.

The presence of mercaptoethanol, thioglycolic acid, and 2-mercaptoethylsulfide may be used as an indicator that a corrosion inhibitor is present in a product or refinery intermediate fluid. Glycols, polyols, polydimethylsiloxanes may indicate the presence of antifoam additives in process fluids. Organic halides, especially C₁-C₁₀ chlorinated solvents may indicate the presence of paraffin control additives, cleaners/degreasers in crude oil.

C₁-C₂₂ organic acids may indicate the presence of lubricity additives in fuels. Hydroxyacids may be used for determining the presence of contaminant removal chemicals in refinery fluids. The presence of imidazoline, alkyl pyridine quaternary compounds, imides, amides, thiophosphate esters, phosphate esters, polyamines, dimethyl fatty amines, & quaternized dimethyl fatty amines may be used to monitor corrosion inhibitors in production fluids or refinery fluids. Ethylene vinylacetate may be used to monitor for the presence of cold flow additives in fuels.

Petrochemical industrial fluids may be monitored for the presence of compounds such as phenylenediamine (PDA), hindered phenols, and organic nitroxides. Oxygen scavengers such as hydroxylamines, nitrites, sulfites, N,N′-diethyl hydroxylamine, hydrazine and ascorbic acid may also be of interest in such fluids and may be monitored using the process of the disclosure. NOx/SOx compounds may be of interest in industrial fluids anywhere where such compounds may be discharged to the environment. The process of the disclosure may be used to determine the presence of spent/available organic nitroxides in petrochemical fluids for monitoring stability additives.

Waste water is another industrial fluid for which the process of the disclosure is particularly desirable. In one embodiment, the process of the disclosure is used to monitor triazoles and polytriazoles in waste water. The concentration of biocides and waste water may also be determined using the process of the disclosure. Phosphates and phosphonates may also be so monitored. Any other additive which may be used in waste water in which can be monitored by the process of the disclosure is within the scope of the disclosure.

In yet another embodiment, the process of the disclosure may be employed generally in the treated water are known as cooling water/boiler water/process water. For example, boiler water may be monitored for the presence of hydroxylamines. Cooling water may be monitored for the presence of acrylic acids and sulfonic acids as an indication for scale inhibitors. Cooling water systems in general and the effluent from cooling towers in specific may be monitored for the presence of volatile organic compounds both for the purposes of environmental monitoring and as a method of determining the occurrence of leaks.

In another non-limiting embodiment, the process of the disclosure may be employed in specific process streams. In one such embodiment, the process of the disclosure is employed to determine the presence or absence of very low levels of contaminants in alkylation units. Another such embodiment would be one where the process of the disclosure was used to determine whether organic acids, which are very corrosive compounds, were going overhead in a distillation unit.

In another aspect, the invention is a composition comprising an intermediate product or a final product produced in an industrial process employing a field asymmetric ion mobility spectrometer which is used to sample industrial fluids wherein the intermediate product or final product is compositionally distinct from a product prepared not using a DMS apparatus. For example, the process of the disclosure may be employed to monitor the amount of organic acid carried overhead from a distillation unit in a refinery. In one embodiment, the process of this closure is employed to monitor and when necessary, introduce an additive to remove or at least mitigate organic acids being carried overhead into a distillation unit. A fuel produced using this process will necessarily have less acid and be therefore less corrosive. Such a deal would be within the scope of this disclosure.

Another aspect of the invention of the disclosure is a system comprising a DMS spectrometer, a process controller, and an interface between the field asymmetric ion mobility spectrometer, and process controller. In most embodiments the controller will either be a computer or will incorporate one. The interface may be as simple as a data cable or be a remote communication apparatus such as a cell phone, or even some form of radio-satellite telemetry.

In yet another aspect of the invention of the disclosure, a DMS apparatus may be employed to make a determination of the concentration of an analyte of interest and then use that data to prepare a predictive model. For example, ethanolamine may be monitored in a fluid to predict whether that fluid, when passed through a heat exchanger or overhead line, will lead to conditions where a salt (for example, ethanolamine hydrochloride) will form and cause fouling and corrosion.

### EXAMPLES

The following examples are provided to illustrate the present invention. The examples are not intended to limit the scope of the present invention and they should not be so interpreted. Amounts are in weight parts or weight percentages unless otherwise indicated.

### Hypothetical Example 1

### Desalter Effluent

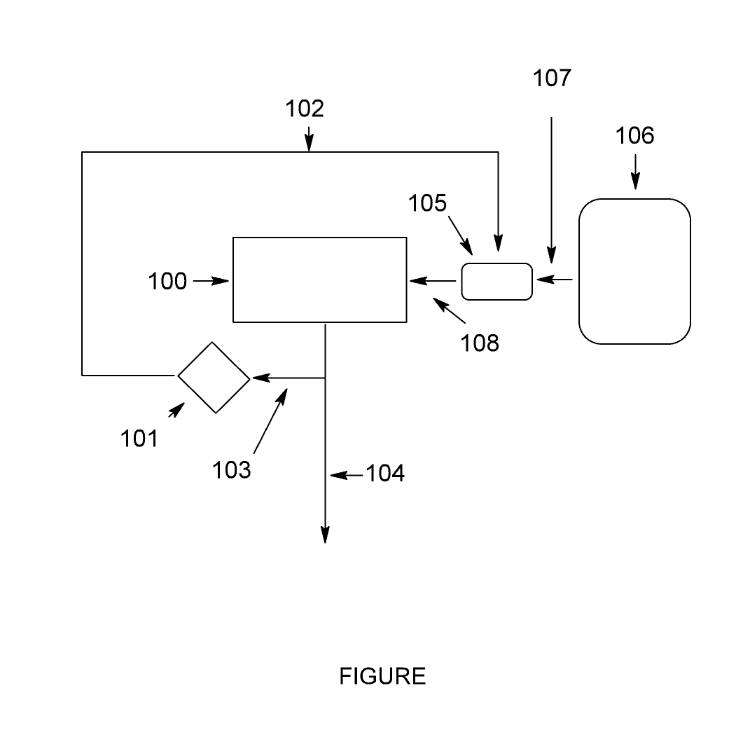

Please see FIG. 1. A desalting unit (100) at a pipeline terminus is monitored using a FAIMS apparatus (101) that outputs a signal (102) indicative of the concentration of acetic and propionic acids. A sample (103) of effluent desalted crude oil (104) is sent to the FAIMS apparatus and the output signal is sent to a Baker Hughes Sentry™ system (105) which in turn is used to control a supply of corrosion inhibitor (106) via conduits (107 and 108). A new stream of production fluid enters the desalting unit which causes an alarm condition indicating high concentrations of acidic compounds to be sent to the Sentry System. The Sentry System then begins to increase the rate of treatment of the influent to the desalting unit until the desalting effluent produces a steady state response by the FAIMS apparatus that is within the preset limits for that unit.

### Hypothetical Example 2

### Refinery Crude Oil Feed to Distillation Unit

A crude oil feed stream being fed to a distillation unit is monitored using a FAIMS apparatus that outputs a signal indicative of the concentration of ethanolamine. The output from the FAIMS apparatus is directed to a controller as a primary input into a distillation control model. The level of ethanol amine is used as a factor in adjusting the feed rates, temperatures, and pressures in the distillation unit to minimize the amount of amines taken overhead in the distillation unit.

### Hypothetical Example 3

### Second Case Refinery Crude Oil Feed to Distillation Unit

The conditions of Example 2 are reproduced substantially identically except that none of the changes implemented to the process are successful in bringing down the amount of ethanolamine going overhead. The controller then initiates an increase in the amount of EXCALIBUR™ contaminates reduction additive.

### Hypothetical Example 4

### Monitoring Boiler Feed Water

A FAIMS instrument is used to monitor the levels of oxygen scavenger (i.e. N,N diethyl hydroxylamine) in boiler feed water as part of a corrosion monitoring program. The instrument also monitors the level of neutralizing amine (cyclohexylamine, morpholine, monoethanolamine, and the like) in steam condensate at various locations throughout the steam circuit. The instrument monitors the distribution of the neutralizers and thus the pH present to control corrosion and allows for more/less of the neutralizer to be added depending on the amounts found.

What is claimed is:

1. A process for monitoring industrial fluids comprising employing differential ion mobility spectrometry to sample the industrial fluids.

2. The process of claim 1 wherein the process further comprises using the differential ion mobility spectrometry to control an industrial process.

3. The process of claim 2 wherein the differential ion mobility spectrometry is performed using a field asymmetric ion mobility spectrometer.

4. The process of claim 3 further comprising conditioning an industrial fluid prior to introducing the industrial fluid into field asymmetric ion mobility spectrometer.

5. The process of claim 2 wherein the industrial fluids are selected from the group consisting of aqueous fluids, non-aqueous fluids, and mixtures of aqueous and nonaqueous fluids.

6. The process of claim 5 wherein the industrial fluids are selected from the group consisting of emulsions and other multiphase fluids which are admixtures of aqueous and non-aqueous fluids.

7. The process of claim 5 wherein the industrial fluids are selected from the group consisting of: fluids present in the exploration for or production of oil and gas, fluids present during the refining of crude oil, and fluids present during the production of chemical products.

8. The process of claim 2 wherein the industrial fluid is selected from the group consisting of cooling water, process water, oil field drilling and completion fluids, oil and gas well production fluids, crude oil, feed streams to desalting units, outflow from desalting units, refinery and chemical plant heat transfer fluids, gas scrubber fluids, chemical plant and refinery unit feed streams, refinery and chemical plant intermediate streams, and refinery and chemical plant production and finished product streams.

9. The process of claim 2 further comprising employing ion mobility spectroscopy to sample the industrial fluids.

10. The process of claim 4 wherein the conditioning of the industrial fluid is performed using a pre-concentrator.

11. The process of claim 4 wherein the conditioning of the industrial fluid is performed using a separation device.

12. The process of claim 2 wherein the ion mobility spectrometry is performed in real time.

13. The process of claim 1 wherein the industrial fluid is ionized employing a process selected from the group consisting of: electrospray ionization, matrix-assisted laser desorption ionization, fast atom bombardment ionization, and chemical ionization.

14. The process of claim 2 wherein the industrial process is controlled by using an output from the differential ion mobility spectrometry to directly control one or more devices within the industrial process.

15. The process of claim 14 wherein the one or more devices is selected from the group consisting of valves and pumps.

16. The process of claim 2 wherein the industrial process is controlled by using an output from the differential ion mobility spectrometry to optimize the dosage of an additive.

17. The process of claim 16 wherein the additive is selected from the group consisting of corrosion inhibitors, hydrate inhibitors, anti-fouling agents, antifoaming agents, anti-scaling agents, demulsifiers, and combinations thereof

18. The process of claim 1 wherein the differential ion mobility spectrometry is employed to make a determination of a concentration of an analyte of interest within the industrial fluid and then the concentration determination is used to prepare a predictive model.

19. A composition comprising an intermediate product or a final product produced in an industrial process employing a field asymmetric ion mobility spectrometry which is used to sample industrial fluids wherein the intermediate product or final product is compositionally distinct from a product prepared not using a differential ion mobility spectrometer.

20. A system comprising a differential ion mobility spectrometer, a process controller, and an interface between the field asymmetric ion mobility spectrometer, and process controller.
